(19) United States
(12) Patent Application Publication
(10) Pub. No.: US 2023/0409511 A1
(43) Pub. Date: Dec. 21, 2023

(54) HARDWARE RESOURCE SELECTION

(71) Applicant: Intel Corporation, Santa Clara, CA (US)

(72) Inventors: Francesc GUIM BERNAT, Barcelona (ES); Eoin WALSH, Limerick (IE); Karthik KUMAR, Chandler, AZ (US); Marcos E. CARRANZA, Portland, OR (US)

(21) Appl. No.: 18/228,617

(22) Filed: Jul. 31, 2023

(51) Int. Cl. G06F 13/42; G06F 13/28

(52) U.S. Cl. CPC G06F 13/4291; G06F 13/28

(57) ABSTRACT

Examples described herein relate to a network interface device. In some examples, the network interface device includes circuitry to: based on a request to process data by a particular operation: determine available hardware resources, where the available hardware resources include a hardware resource in a reduced power state, and select a hardware resource among the available hardware resources based on a data processing measurement for the particular operation.

### BACKGROUND

Edge computing places computing and data storage resources physically closer to data sources and data receivers to reduce latency of processing and accessing data and reduce network bandwidth utilization. Edge cloud architectures utilize network interface devices such as Intel® Infrastructure Processing Units (IPUs) to manage the infrastructure and allow central processing units (CPUs), graphics processing units (GPUs), and other processors (e.g., xPU) to execute core application-level functions. Far edge can include distributed large scale devices (e.g., multitudes of edge appliances) but devices can be limited by power usage and space constraints. Data center edge can include devices with higher computing power and sharing of resources by multiple tenants. On premises edge can combine devices with both far and data center edge characteristics.

Edge cloud architectures can utilize network interface devices such as Intel® Infrastructure Processing Units (IPUs) to manage the infrastructure and allow central processing units (CPUs), graphics processing units (GPUs), and other processors (e.g., xPU) to execute core application-level functions. An IPU can serve as a gateway to a computing platform system so that the IPU can allocate processing of traffic to accelerators in or attached to the IPU.

### BRIEF DESCRIPTION OF THE DRAWINGS

FIG. 1 depicts an example system.

FIG. 2 depicts an example of processing latency.

FIG. 3 depicts an example process.

FIGS. 4A and 4B depict example network interface devices.

FIG. 5 depicts an example network interface device.

FIG. 6 depicts an example system.

### DETAILED DESCRIPTION

Accelerators can be utilized in multi-tenancy environments with tenant-specific service level agreements (SLAs) and/or quality of service (QoS) requirements and accelerator resources attached to an IPU or central processing unit (CPU) can be selected that meet applicable SLAs or QoS requirements. An IPU can process data with a hardware device (e.g., accelerators or other processors or circuitry) that are part of a system on chip (SoC) or connected via a bus or interconnect, Peripheral Component Interconnect Express (PCIe) or Compute Express Link (CXL) connected hardware device, or hardware device connected to a host system. To select a particular hardware device to process a data stream with an associated SLA or QoS, a data processing measurement can be accessed. In some examples, the data processing measurement can indicate a duration (e.g., time, number of clock cycles) or priority level of hardware resource to process the data stream (e.g., high, medium low) that are to be used to select a hardware resource to process the data stream. For example, a time or number of clock cycles to complete processing of the data stream can be based on a static distance of the hardware device from the IPU can be considered, type of hardware device, and load on hardware device can be considered. However, a hardware device that is in a low power or sleep state may not be considered as a candidate to process the data stream.

Some examples described herein can select a hardware device among candidate hardware devices by considering a data processing measurement of a data stream by a hardware device that is in a low power or sleep state as well as considering a data processing measurement to perform processing of the data stream by other hardware devices that are powered up and operational. For example, if hardware devices that are powered up and available to process loads do not meet a data processing measurement or an SLA or QoS associated with a data stream, a determination can be made if the data processing measurement or an SLA or QoS of the data stream can be met by a hardware device that is in a low power or sleep state. For example, a data processing measurement or an SLA or QoS of the hardware device that is in a low power or sleep state can be based on a time or number of clock cycles to wake up an interconnect to the hardware device and time or number of clock cycles for hardware device to power up and process data as well as a priority level of the hardware device. Time or number of clock cycles to complete processing of the data stream can be based on frequency enhancement applied to powered up hardware devices or hardware devices that were in low power state and powered-up to wake up the hardware device faster and reduce time or number of clock cycles to complete processing of a data stream.

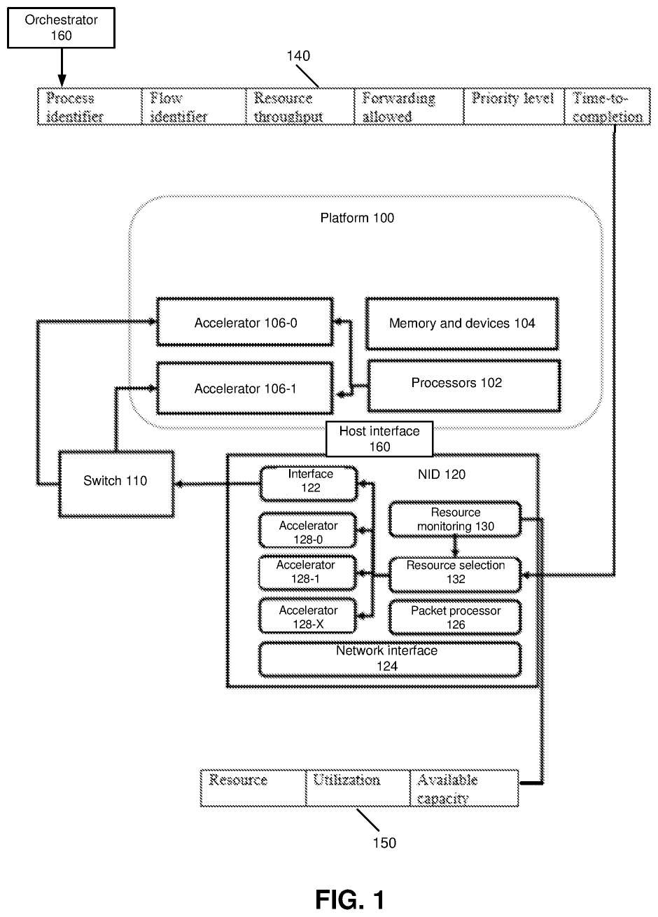

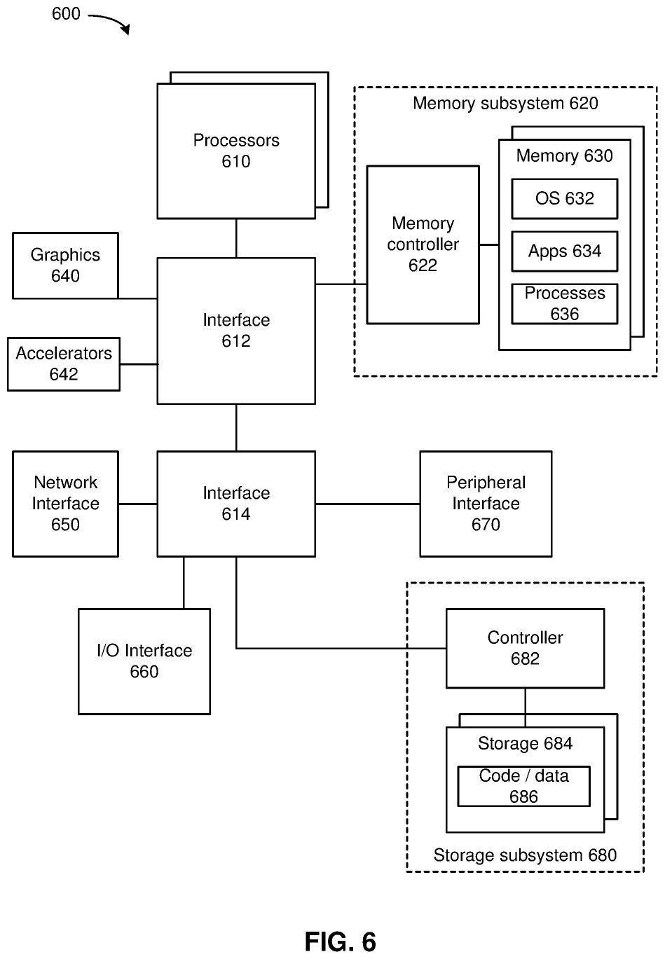

FIG. 1 depicts an example system. Platform 100 can include processors 102, memory and devices 104, and at least accelerators 106-0 to 106-1 and other circuitry and software described at least with respect to FIG. 6. Platform 100 can be communicatively coupled to network interface device (NID) 120 via host interface 160. Although a single NID is shown, multiple NIDs can be coupled to platform 100 via host interface 160. Various examples of host interface 160 can utilize protocols based on Peripheral Component Interconnect Express (PCIe), Compute Express Link (CXL), or others as well as virtual device interfaces.

For example, a system software stack (e.g., operating system (OS)) or orchestrator, if authenticated, can configure operations of resource selection 132 by configuration 140. For example, configuration 140 can specify, for a particular service or device represented with a process address spaced identifier (PASID) and a particular flow represented by a network identifier (e.g., source Internet Protocol (IP), source media access control (MAC) address, or other packet header field), one or more of: data processing measurement, SLA or QoS, a priority level of a hardware resource that is to process the data, operations to process data associated with the flow (e.g., encryption, decryption, compression, decompression, algebraic operations, machine learning (ML), or others), forwarding allowed (e.g., whether circuitry connected through a host interface 160 or switch 110 can be used to process the data), associated low-end permitted compute and performance characteristics (e.g., operations per second), or upper end permitted time-to-completion. A time-to-completion (or number of clock cycles to completion) can include time or number of clock cycles to copy data to memory accessible by the circuitry and time or number of clock cycles to process the data by the circuitry. Circuitry can include processors or accelerators that can be in or part of network interface device 120 (e.g., accelerators 128-0 to 128-X, where X is an integer) or accelerators or processors communicatively coupled via switch 110 (e.g., accelerators 106-0 to 106-1). For example, accelerators 128-0 to 128-X can be enclosed in a case or enclosure that encompasses network interface device 120 as well as circuitry of network interface device 120 and include a circuit board to provide communications among circuitry of network interface device 120.

Resource monitoring 130 can periodically generate utilization data 150 based on monitored load and power states of circuitry (e.g., accelerators 106-0, 106-1, 128-0 to 128-X, and other processors), as well as utilized transmit bandwidth of switch 110 and other connection circuitry and memory utilization of memory or cache that store data to be processed by the circuitry. Resource monitoring 130 can utilize artificial intelligence (AI) models to estimate utilization of circuitry, switch 110, and other connection circuitry and memory utilization of memory.

In some examples, based on utilization data 150, resource monitoring 130 can include a vector that can map occupancy thresholds to priority thresholds can be used by resource selection 132 to determine whether to select a particular circuitry to process the data or not. For example, a priority vector format can be as follows:
Priority_vector={{Usage_threshold1, Priority1}, . . . {Usage_thresholdn, Priorityn}}, where n represents a service identifier and flow identifier pair.
   A priority vector can indicate a particular low end usage level of a circuitry that is permitted for a particular priority level of a process (e.g., service) identifier and flow identifier.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

Packet processor 126 can parse a header of a received packet to identify an associated service identifier and flow identifier. The service identifier can be determined based on header field content. Packet processor 126 can provide the service identifier and flow identifier to resource selection 132. Based on a configuration for a service identifier and flow identifier stored in configuration 140, resource selection 132 can select a circuitry to process the packet. However, if a configuration for a service identifier and flow identifier is not present in configuration 140, then resource selection 132 can select an available circuitry or processor that can apply best efforts for processing the data.

Resource selection 132 can determine circuitry to process a network packet (e.g., header and/or payload) or other data. In some examples, resource selection 132 can determine circuitry to process packets of a flow prior to receipt of a packet of the flow and apply the determination to other packets of the flow. In some examples, resource selection 132 can determine circuitry to process packets of a flow after receipt of a first packet of the flow and apply the determination to other packets of the flow. Resource selection 132 can identify data processing measurement, an SLA or QoS, or estimated response time or number of clock cycles of candidate circuitries to process the network packet or other data based on utilization data 150 from resource monitoring 130. For example, an estimated response time or number of clock cycles of candidate circuitries to process the network packet or other data can be based on time or number of clock cycles to copy the network packet or other data to memory accessible to the candidate circuitry, estimated time or number of clock cycles to complete processing of the network packet or other data given a utilization of the circuitry, and permit the processed network packet or other data to be accessed by circuitry of NID 120 or platform 100 for subsequent processing or transmission in a packet. In some examples, resource monitoring 130 and/or resource selection 132 can determine a likelihood that circuitry will be used in the future and can consider such likelihood of use in determining load on the circuitry.

In some examples, resource selection 132 can determine complexity of processing a received packet header and/or payload and determined estimated time or number of clock cycles to complete processing of the network packet or other data based on the determined complexity. In some examples, a received packet can include metadata in a header field and/or payload and the metadata can indicate a level of processing resources or time or number of clock cycles estimated to process the data. Generally, a higher complexity can indicate a longer estimated time or number of clock cycles to complete processing of the network packet or other data, whereas a lower complexity can indicate a shorter estimated time or number of clock cycles to complete processing of the network packet or other data.

In some examples, a packet can be associated with a flow and configuration 140 can indicate circuitry selection priorities for one or more flows. Based on configuration 140, resource selection 132 can select an accelerator based on priority associated with the flow. For example, for one or more flows, configuration 140 can indicate accelerators in NID 120 (e.g., accelerator 128-0, 128-1, or 128-X) are to be prioritized for selection over accelerators in platform 100 (e.g., accelerator 106-0 or 106-1) or accelerators in platform 100 (e.g., accelerator 106-0 or 106-1) are to be prioritized for selection over accelerators in NID 120 (e.g., accelerator 128-0, 128-1, or 128-X). For example, for one or more flows, configuration 140 can indicate a particular accelerator is to be selected if its current usage is below a certain level of load (which can be configurable or adaptive) and it has enough capacity to process a data processing request.

In some examples, a circuitry can be in one of several states: (1) resource on (e.g., interconnect to circuitry and circuitry are powered-on), (2) resource on but in reduced power state, or (3) resource powered off. In some examples, resource monitoring 130 and/or resource selection 132 can determine a time or number of clock cycles to process data by circuitry that is in a low or reduced power state or powered off state. Resource monitoring 130 and/or resource selection 132 can determine a latency to process data by a candidate circuitry based on a time or number of clock cycles to transmit data over a link (e.g., switch 110, host interface 160, or an interconnect in NID 120) to the candidate circuitry, including a time or number of clock cycles to wake up or power up the link between NID 120 and the candidate circuitry to transfer data at a particular throughput level, as well as time or number of clock cycles to wake up or power up the candidate circuitry to operate at a particular throughput level, and can consider use of turbo boost or other manner of ramping increases to power and/or frequency of operation of the candidate circuitry. If the time for the candidate circuitry to process the data is within a permitted time-to-completion (or number of clock cycles), the candidate circuitry can be selected.

Resource selection 132 can select a circuitry based on distance from NID 120. For example, circuitry in NID 120 can be more physically proximate than processors 102 and accelerators 106-0 and 106-1 in platform 100. Due to proximity to NID 120, accelerators of NID 120 may meet more critical and/or difficult-to-meet SLAs than those of accelerators of platform 100.

Based on selection of one or more circuitry to process the data, resource selection 132 can cause the packet headers, packet payloads, and/or other data to be provided to the selected accelerator on NID 120 or platform 100. For example, NID 120 can forward the packet headers, packet payloads, and/or other data to a circuitry on platform 100 selected by resource selection 132 via switch 110. For example, switch 110 can communicatively couple accelerators 106-0 to 106-1 with NID 120 so that resource selection 132 can provide data for processing by one or more of accelerators 106-0 to 106-1 as well as accelerators 128-0 to 128-X. Switch 110 can utilize protocols such as Compute Express Link (CXL) protocol (e.g., Compute Express Link (CXL) Specification version 1.0 (2019), as well as earlier versions, later versions, and variations thereof).

Based on selection of one or more circuitry to process the data, resource selection 132 can cause the packet headers, packet payloads, and/or other data to be provided to the selected accelerator on NID 120, part of platform 100 can be powered-off or enter reduced power state. For example, processors 102 and/or accelerators 106-0 to 106-1 can be powered-off or enter reduced power state.

In some examples, processors 102, memory and devices 104, and at least accelerators 106-0 to 106-1 of platform 100 can be positioned in a same integrated circuitry, system on chip (SoC), package, die, or encasement. In some examples, interface 122, network interface 124, packet processor 126, accelerators 128-0 to X, resource monitoring 130, and/or resource selection 132 can be positioned in a same integrated circuitry, SoC, package, die, or encasement. The processors 102, memory and devices 104, and at least accelerators 106-0 to 106-1 of platform 100 can be positioned in a different integrated circuitry, SoC, package, die, or encasement than that of interface 122, network interface 124, packet processor 126, accelerators 128-0 to X, resource monitoring 130, and resource selection 132. A semiconductor package can include metal, plastic, glass, and/or ceramic casing that encompass and provide communications within or among one or more semiconductor devices or integrated circuits.

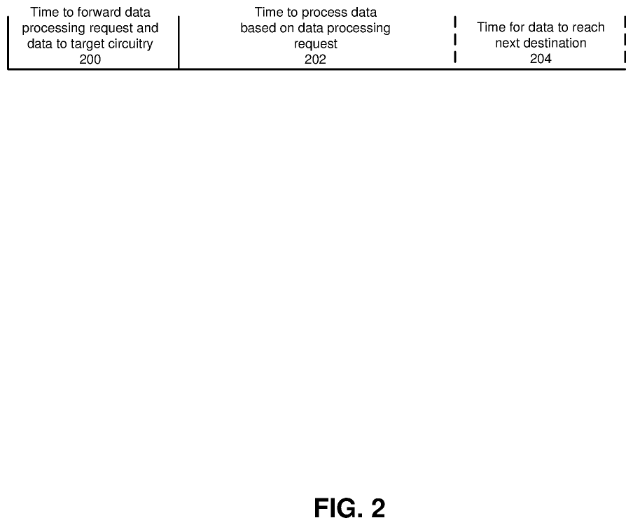

FIG. 2 depicts an example of time or number of clock cycles to process data. For example, time segment 200 can include a time or number of clock cycles to copy data to memory or cache accessible to a target circuitry. For example, data can be copied to a target circuitry (e.g., by direct memory access (DMA) operation) or copied by the target circuitry by accessing data referenced by a pointer. In some examples, time to copy data to the circuitry can be based on time to traverse a switch or link. Target circuitry can include one or more accelerators, processors, memory, compute-in-memory, or other circuitry.

Time segment 202 can include time or number of clock cycles to process the data by the target circuitry in accordance with the data processing request. Time or number of clock cycles to process the data by the target circuitry can be based on size of data and type of operation to perform (e.g., decryption, encryption, compression, decompression, summation, find minimum, find maximum, multiplication, subtraction, or others). Time or number of clock cycles to process the data by the target circuitry in accordance with the data processing request can be based on expected throughput of the target circuitry based on a processing load of the target circuitry.

Time segment 204 can include time or number of clock cycles for data to be available at a next destination memory device. Note that time segment 204 may not be included in a determined time or number of clock cycles to process data. Note that reference to data can include an entirety or strict subset of one or more of: header, payload data, or metadata.

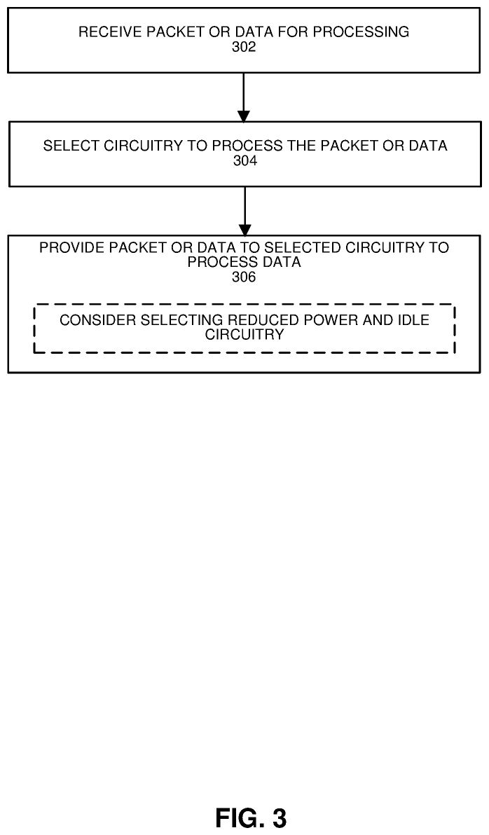

FIG. 3 depicts an example process. The process can be performed by circuitry, processor-executed software, and/or firmware of a network interface device. The process can be performed by components of the system of FIG. 1. Although examples are described with respect to a network interface device, the process of FIG. 3 can be applied to other devices, such as graphics processing units (GPUs), accelerators, memory pools, storage interfaces, and so forth. At 302, a packet can be received by the network interface device. The packet can include header and/or payload data that are to be processed by processor-executed software and/or accelerator(s) (e.g., field programmable gate array (FPGA), application specific integrated circuit (ASIC), and/or other circuitry). In some examples, the packet can be associated with a particular flow or service and a configuration can specify criteria for selecting processor-executed software and/or accelerator(s) to process the data for the particular flow or service.

At 304, based on the configuration, selection of processor-executed software and/or accelerator(s) to process the header and/or data can occur. In some examples, criteria for selecting processor-executed software and/or accelerator(s) to process the data can include one or more of: a flow identifier, a PASID of the service, priority level of the processor-executed software and/or accelerator(s), SLA or QoS level(s), a low-end permitted rate of operations that can be performed by the processor-executed software and/or accelerator(s), an indication whether the header and/or data is permitted to be processed by processor-executed software and/or accelerator(s) that are connected to the network interface device via a switch or host interface, priority level of data processing, or a time or number of clock cycles to completion of processing the header and/or data. In some examples, processor-executed software and/or accelerator(s) that are in a sleep or reduced power state and that are not processing header and/or data can be considered for selection and the time or number of clock cycles to completion of processing header and/or data by the processor-executed software and/or accelerator(s) that are in a sleep or reduced power state can include time or number of clock cycles to wake up the processor-executed software and/or accelerator(s) that are in a sleep or reduced power state. For example, time or number of clock cycles to completion of processing the header and/or data for a particular processor-executed software and/or accelerator can be based on time or number of clock cycles to copy header and/or data to the particular processor-executed software and/or accelerator(s) (or for the particular processor-executed software and/or accelerator(s) to access the header and/or data) and time or number of clock cycles for the particular processor-executed software and/or accelerator(s) to process the header and/or data. In some examples, time or number of clock cycles to copy header and/or data to the particular processor-executed software and/or accelerator(s) (or for the particular processor-executed software and/or accelerator(s) to access the header and/or data) can be based on time or number of clock cycles to traverse a switch or link. Time or number of clock cycles for the particular processor-executed software and/or accelerator(s) to process the header and/or data can be based on size of the header and/or data and type of operation to perform (e.g., decryption, encryption, compression, decompression, summation, find minimum, find maximum, multiplication, subtraction, or others).

Selection of processor-executed software and/or accelerator(s) to process the header and/or data can be based on calculation or accessing previously calculated time or number of clock cycles to completion of processing the header and/or data. The calculated time or number of clock cycles to completion of processing the header and/or data by a particular processor or accelerator can be stored and accessed for future use to reduce time or number of clock cycles to select a processor or accelerator.

At 306, based on selection of a processor-executed software and/or accelerator(s), the header and/or data can be copied or made available via pointers for processing by the processor-executed software and/or accelerator(s).

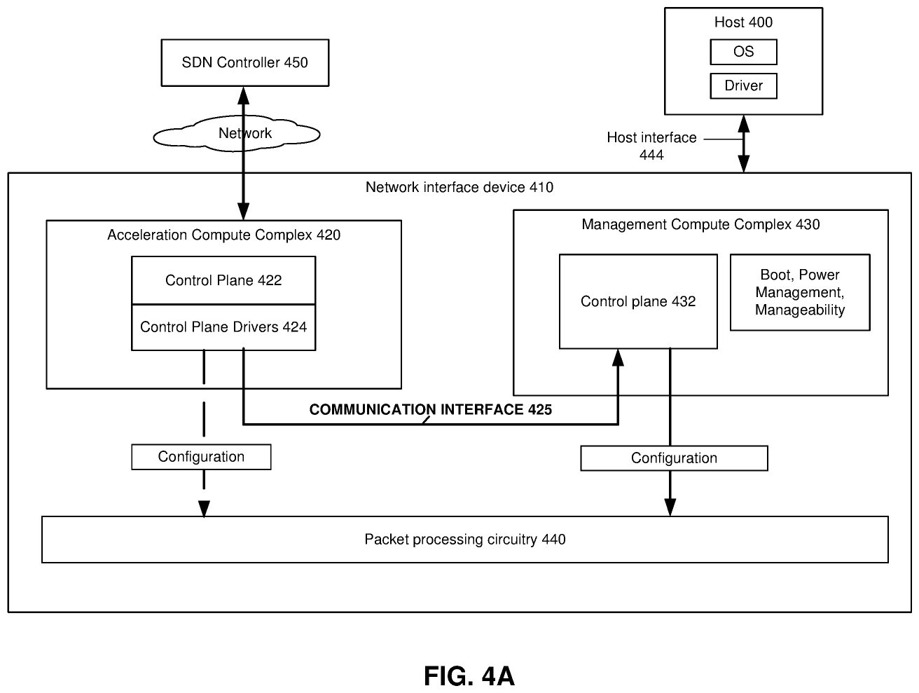

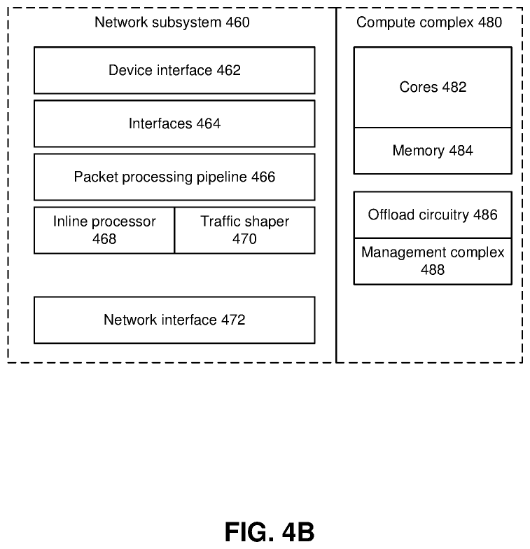

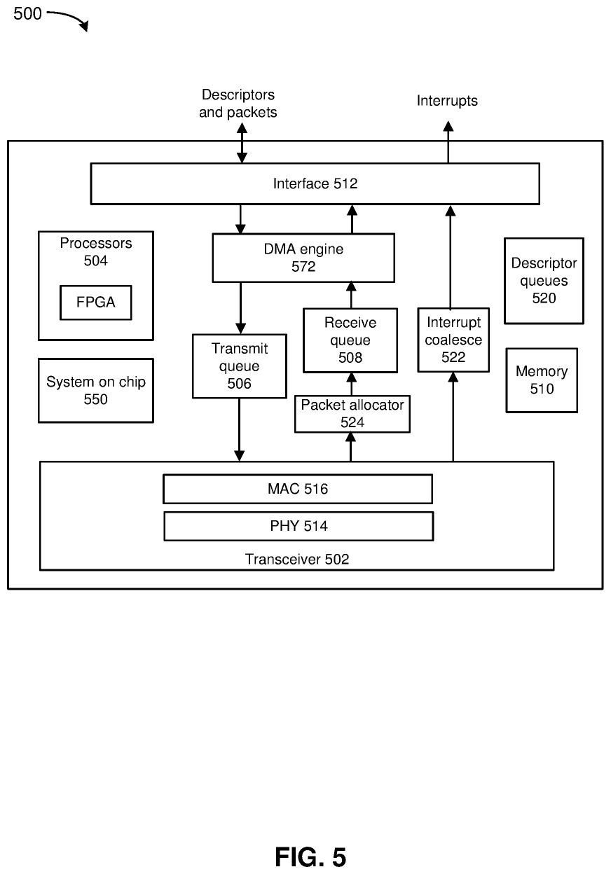

FIG. 4A depicts an example system. Host 400 can include processors, memory devices, device interfaces, as well as other circuitry such as described with respect to one or more of FIGS. 4B, 5, and/or 6. Processors of host 400 can execute software such as applications (e.g., microservices, virtual machine (VMs), microVMs, containers, processes, threads, or other virtualized execution environments), operating system (OS), and device drivers. An OS or device driver can configure network interface device or packet processing device 410 to utilize one or more control planes to communicate with software defined networking (SDN) controller 450 via a network to configure operation of the one or more control planes.

Packet processing device 410 can include multiple compute complexes, such as an Acceleration Compute Complex (ACC) 420 and Management Compute Complex (MCC) 430, as well as packet processing circuitry 440 and network interface technologies for communication with other devices via a network. ACC 420 can be implemented as one or more of: a microprocessor, processor, accelerator, field programmable gate array (FPGA), application specific integrated circuit (ASIC) or circuitry described at least with respect to FIGS. 4B, 5, and/or 6. Similarly, MCC 430 can be implemented as one or more of: a microprocessor, processor, accelerator, field programmable gate array (FPGA), application specific integrated circuit (ASIC) or circuitry described at least with respect to FIGS. 4B, 5, and/or 6. In some examples, ACC 420 and MCC 430 can be implemented as separate cores in a CPU, different cores in different CPUs, different processors in a same integrated circuit, different processors in different integrated circuit.

Packet processing device 410 can be implemented as one or more of: a microprocessor, processor, accelerator, field programmable gate array (FPGA), application specific integrated circuit (ASIC) or circuitry described at least with respect to FIGS. 4B, 5, and/or 6. Packet processing pipeline circuitry 440 can process packets as directed or configured by one or more control planes executed by multiple compute complexes. In some examples, ACC 420 and MCC 430 can execute respective control planes 422 and 432.

As described herein, packet processing device 410, ACC 420, and/or MCC 430 can be configured to select an accelerator or other circuitry to process data from received packets, including reduced power or idle accelerators or circuitry based on a data processing measurement.

SDN controller 450 can upgrade or reconfigure software executing on ACC 420 (e.g., control plane 422 and/or control plane 432) through contents of packets received through packet processing device 410. In some examples, ACC 420 can execute control plane operating system (OS) (e.g., Linux) and/or a control plane application 422 (e.g., user space or kernel modules) used by SDN controller 450 to configure operation of packet processing pipeline 440. Control plane application 422 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 450 can communicate with ACC 420 using a remote procedure call (RPC) such as Google remote procedure call (gRPC) or other service and ACC 420 can convert the request to target specific protocol buffer (protobuf) request to MCC 430. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 450 can provide packet processing rules for performance by ACC 420. For example, ACC 420 can program table rules (e.g., header field match and corresponding action) applied by packet processing pipeline circuitry 440 based on change in policy and changes in VMs, containers, microservices, applications, or other processes. ACC 420 can be configured to provide network policy as flow cache rules into a table to configure operation of packet processing pipeline 440. For example, the ACC-executed control plane application 422 can configure rule tables applied by packet processing pipeline circuitry 440 with rules to define a traffic destination based on packet type and content. ACC 420 can program table rules (e.g., match-action) into memory accessible to packet processing pipeline circuitry 440 based on change in policy and changes in VMs.

For example, ACC 420 can execute a virtual switch such as vSwitch or Open vSwitch (OVS), Stratum, or Vector Packet Processing (VPP) that provides communications between virtual machines executed by host 400 or with other devices connected to a network. For example, ACC 420 can configure packet processing pipeline circuitry 440 as to which VM is to receive traffic and what kind of traffic a VM can transmit. For example, packet processing pipeline circuitry 440 can execute a virtual switch such as vSwitch or Open vSwitch that provides communications between virtual machines executed by host 400 and packet processing device 410.

MCC 430 can execute a host management control plane, global resource manager, and perform hardware registers configuration. Control plane 432 executed by MCC 430 can perform provisioning and configuration of packet processing circuitry 440. For example, a VM executing on host 400 can utilize packet processing device 410 to receive or transmit packet traffic. MCC 430 can execute boot, power, management, and manageability software (SW) or firmware (FW) code to boot and initialize the packet processing device 410, manage the device power consumption, provide connectivity to Baseboard Management Controller (BMC), and other operations.

One or both control planes of ACC 420 and MCC 430 can define traffic routing table content and network topology applied by packet processing circuitry 440 to select a path of a packet in a network to a next hop or to a destination network-connected device. For example, a VM executing on host 400 can utilize packet processing device 410 to receive or transmit packet traffic.

ACC 420 can execute control plane drivers to communicate with MCC 430. At least to provide a configuration and provisioning interface between control planes 422 and 432, communication interface 425 can provide control-plane-to-control plane communications. Control plane 432 can perform a gatekeeper operation for configuration of shared resources. For example, via communication interface 425, ACC control plane 422 can communicate with control plane 432 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 425 can be utilized by a negotiation protocol and configuration protocol running between ACC control plane 422 and MCC control plane 432. Communication interface 425 can include a general purpose mailbox for different operations performed by packet processing circuitry 440. Examples of operations of packet processing circuitry 440 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 425 can include one or more mailboxes accessible as registers or memory addresses. For communications from control plane 422 to control plane 432, communications can be written to the one or more mailboxes by control plane drivers 424. For communications from control plane 432 to control plane 422, communications can be written to the one or more mailboxes. Communications written to mailboxes can include descriptors which include message opcode, message error, message parameters, and other information. Communications written to mailboxes can include defined format messages that convey data.

Communication interface 425 can provide communications based on writes or reads to particular memory addresses (e.g., dynamic random access memory (DRAM)), registers, other mailbox that is written-to and read-from to pass commands and data. To provide for secure communications between control planes 422 and 432, registers and memory addresses (and memory address translations) for communications can be available only to be written to or read from by control planes 422 and 432 or cloud service provider (CSP) software executing on ACC 420 and device vendor software, embedded software, or firmware executing on MCC 430. Communication interface 425 can support communications between multiple different compute complexes such as from host 400 to MCC 430, host 400 to ACC 420, MCC 430 to ACC 420, baseboard management controller (BMC) to MCC 430, BMC to ACC 420, or BMC to host 400.

Packet processing circuitry 440 can be implemented using one or more of: application specific integrated circuit (ASIC), field programmable gate array (FPGA), processors executing software, or other circuitry. Control plane 422 and/or 432 can configure packet processing pipeline circuitry 440 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 420 or MCC 430. In some examples, a P4 program can be compiled and provided to MCC 430 to configure packet processing circuitry 440. The following is a JSON configuration file that can be transmitted from ACC 420 to MCC 430 to get capabilities of packet processing circuitry 440 and/or other circuitry in packet processing device 410. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 4B depicts an example network interface device system. Various examples of packet processing device or network interface device 410 can utilize components of the system of FIG. 4B. In some examples, packet processing device or network interface device can refer to one or more of: a network interface controller (NIC), a remote direct memory access (RDMA)-enabled NIC, SmartNIC, router, switch, forwarding element, infrastructure processing unit (IPU), or data processing unit (DPU). Network subsystem 460 can be communicatively coupled to compute complex 480. Device interface 462 can provide an interface to communicate with a host. Various examples of device interface 462 can utilize protocols based on Peripheral Component Interconnect Express (PCIe), Compute Express Link (CXL), or others as well as virtual device interfaces.

Interfaces 464 can initiate and terminate at least offloaded remote direct memory access (RDMA) operations, Non-volatile memory express (NVMe) reads or writes operations, and LAN operations. Packet processing pipeline 466 can perform packet processing (e.g., packet header and/or packet payload) based on a configuration and support quality of service (QoS) and telemetry reporting. Inline processor 468 can perform offloaded encryption or decryption of packet communications (e.g., Internet Protocol Security (IPSec) or others). Traffic shaper 470 can schedule transmission of communications. Network interface 472 can provide an interface at least to an Ethernet network by media access control (MAC) and serializer/de-serializer (Serdes) operations.

Cores 482 can be configured to perform infrastructure operations such as storage initiator, Transport Layer Security (TLS) proxy, virtual switch (e.g., vSwitch), or other operations. Memory 484 can store applications and data to be performed or processed. Offload circuitry 486 can perform at least cryptographic and compression operations for host or use by compute complex 480. Offload circuitry 486 can include one or more graphics processing units (GPUs) that can access memory 484. Management complex 488 can perform secure boot, life cycle management and management of network subsystem 460 and/or compute complex 480.

FIG. 5 depicts an example network interface device or packet processing device. In some examples, circuitry of network interface device can be utilized by network interface 410 or another network interface for packet transmissions and packet receipts, as described herein. In some examples, packet processing device 500 can be implemented as a network interface controller, network interface card, a host fabric interface (HFI), or host bus adapter (HBA), and such examples can be interchangeable. Packet processing device 500 can be coupled to one or more servers using a bus, PCIe, CXL, or Double Data Rate (DDR). Packet processing device 500 may be embodied as part of a system-on-a-chip (SoC) that includes one or more processors, or included on a multichip package that also contains one or more processors.

Some examples of packet processing device 500 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and bus interface 512, and DMA engine 552. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to assemble data to be transmitted into packets, that include destination and source addresses along with network control information and error detection hash values.

Processors 504 can be any a combination of a: processor, core, graphics processing unit (GPU), field programmable gate array (FPGA), application specific integrated circuit (ASIC), or other programmable hardware device that allow programming of network interface 500. For example, a “smart network interface” can provide packet processing capabilities in the network interface using processors 504.

Processors 504 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 504, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

As described herein, processors 504 or other circuitry can be configured to select an accelerator or other circuitry to process data from received packets, including reduced power or idle accelerators or circuitry based on a data processing measurement.

Packet allocator 524 can provide distribution of received packets for processing by multiple CPUs or cores using timeslot allocation described herein or RSS. When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with PCI, PCI Express, PCI-x, Serial ATA, and/or USB compatible interface (although other interconnection standards may be used).

FIG. 6 depicts a system. In some examples, circuitry of network interface device can be utilized to select an accelerator or other circuitry to process data from received packets, including reduced power or idle accelerators or circuitry based on a data processing measurement, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a display that provides an output to a user. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 5.

In some examples, network interface 650 can be configured to select an accelerator or other circuitry to process data from received packets, including reduced power or idle accelerators or circuitry based on a data processing measurement, as described herein.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. A non-volatile memory (NVM) device is a memory whose state is determinate even if power is interrupted to the device.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniB and, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a network interface device comprising: direct memory access (DMA) circuitry, a network interface, a host interface, an interface, and circuitry to: for a packet flow, determine available hardware resources, wherein the available hardware resources include a hardware resource in a reduced power state and based on receipt of a packet of the packet flow comprising data to process by a particular operation, select a hardware resource in the reduced power state to process the data based on the data processing measurement.

Example 2 includes one or more examples, wherein the data processing measurement comprises one or more of: time or number of clock cycles to process data or priority level of hardware resource to process the data.

Example 3 includes one or more examples, wherein the network interface device includes at least one hardware resource of the available hardware resources, a host system includes at least one hardware resource of the available hardware resources, and the at least one hardware resource of the available hardware resources of the network interface device and the at least one hardware resource of the available hardware resources of the host system are in different packages.

Example 4 includes one or more examples, wherein the data processing measurement is based on power up of the interface and the hardware resource in the reduced power state to operate at a first level of processing.

Example 5 includes one or more examples, wherein the first level of processing comprises a data processing rate associated with a power consumption level that is higher than a power consumption level of the reduced power state.

Example 6 includes one or more examples, wherein the interface is consistent with a Compute Express Link (CXL) protocol.

Example 7 includes one or more examples, wherein the select a hardware resource in the reduced power state to process the data based on the data processing measurement is to prioritize use of a hardware resource in the network interface device.

Example 8 includes one or more examples, and includes a non-transitory computer-readable medium comprising instructions stored thereon, that if executed by one or more processors, cause the one or more processors to: configure a network interface device to: based on receipt of a packet with data to process by a particular operation: determine available hardware resources, wherein the available hardware resources include a hardware resource in a reduced power state device and select a hardware resource among the available hardware resources based on a data processing measurement for the particular operation.

Example 9 includes one or more examples, wherein the data processing measurement for the particular operation comprise one or more of: time or number of clock cycles to process data or priority level of hardware resource to process the data.

Example 10 includes one or more examples, wherein the data processing measurement is based on power up of an interface to the hardware resource in the reduced power state and the hardware resource in the reduced power state to operate at a first level of processing.

Example 11 includes one or more examples, wherein the first level of processing comprises a data processing rate associated with a power consumption level that is higher than a power consumption level of the reduced power state.

Example 12 includes one or more examples, wherein the available hardware resources comprise hardware resources enclosed in a casing that encompasses the network interface device.

Example 13 includes one or more examples, wherein the available hardware resources comprise hardware resources connected to the network interface device via an interface and hardware resources enclosed in a casing that encompasses the network interface device.

Example 14 includes one or more examples, wherein the select a hardware resource among the available hardware resources based on a data processing measurement for the particular operation is to prioritize use of a hardware resource in the network interface device.

Example 15 includes one or more examples, and includes a computer-implemented method that includes: at a network interface device: based on a request to process data by a particular operation: determining available hardware resources, wherein the available hardware resources include a hardware resource in a reduced power state and selecting a hardware resource among the available hardware resources based on a data processing measurement for the particular operation.

Example 16 includes one or more examples, wherein the data processing measurement for the particular operation comprise one or more of: time or number of clock cycles to process data or priority level of hardware resource to process the data.

Example 17 includes one or more examples, wherein the data processing measurement is based on power up of an interface to the hardware resource in the reduced power state and the hardware resource in the reduced power state to operate at a first level of processing.

Example 18 includes one or more examples, wherein the available hardware resources comprise hardware resources enclosed in a casing that encompasses the network interface device.

Example 19 includes one or more examples, wherein the available hardware resources comprise hardware resources connected to the network interface device via an interface.

Example 20 includes one or more examples, wherein the selecting the hardware resource among the available hardware resources based on a time to process the data by the particular operation is to prioritize use of a hardware resource in the network interface device.

1. An apparatus comprising:
a network interface device comprising:
direct memory access (DMA) circuitry,
a network interface,
a host interface,
an interface, and
circuitry to:
for a packet flow, determine available hardware resources, wherein the available hardware resources include a hardware resource in a reduced power state and
based on receipt of a packet of the packet flow comprising data to process by a particular operation, select a hardware resource in the reduced power state to process the data based on the data processing measurement.

2. The apparatus of claim 1, wherein the data processing measurement comprises one or more of: time or number of clock cycles to process data or priority level of hardware resource to process the data.

3. The apparatus of claim 1, wherein
the network interface device includes at least one hardware resource of the available hardware resources,
a host system includes at least one hardware resource of the available hardware resources, and
the at least one hardware resource of the available hardware resources of the network interface device and the at least one hardware resource of the available hardware resources of the host system are in different packages.

4. The apparatus of claim 1, wherein the data processing measurement is based on power up of the interface and the hardware resource in the reduced power state to operate at a first level of processing.

5. The apparatus of claim 4, wherein the first level of processing comprises a data processing rate associated with a power consumption level that is higher than a power consumption level of the reduced power state.

6. The apparatus of claim 1, wherein the interface is consistent with a Compute Express Link (CXL) protocol.

7. The apparatus of claim 1, wherein the select a hardware resource in the reduced power state to process the data based on the data processing measurement is to prioritize use of a hardware resource in the network interface device.

8. A non-transitory computer-readable medium comprising instructions stored thereon, that if executed by one or more processors, cause the one or more processors to:
configure a network interface device to:
based on receipt of a packet with data to process by a particular operation:
determine available hardware resources, wherein the available hardware resources include a hardware resource in a reduced power state device and
select a hardware resource among the available hardware resources based on a data processing measurement for the particular operation.

9. The computer-readable medium of claim 8, wherein the data processing measurement for the particular operation comprise one or more of: time or number of clock cycles to process data or priority level of hardware resource to process the data.

10. The computer-readable medium of claim 8, wherein the data processing measurement is based on power up of an interface to the hardware resource in the reduced power state and the hardware resource in the reduced power state to operate at a first level of processing.

11. The computer-readable medium of claim 10, wherein the first level of processing comprises a data processing rate associated with a power consumption level that is higher than a power consumption level of the reduced power state.

12. The computer-readable medium of claim 8, wherein the available hardware resources comprise hardware resources enclosed in a casing that encompasses the network interface device.

13. The computer-readable medium of claim 9, wherein the available hardware resources comprise hardware resources connected to the network interface device via an interface and hardware resources enclosed in a casing that encompasses the network interface device.

14. The computer-readable medium of claim 8, wherein the select a hardware resource among the available hardware resources based on a data processing measurement for the particular operation is to prioritize use of a hardware resource in the network interface device.

15. A computer-implemented method comprising:
at a network interface device:
based on a request to process data by a particular operation:
determining available hardware resources, wherein the available hardware resources include a hardware resource in a reduced power state and
selecting a hardware resource among the available hardware resources based on a data processing measurement for the particular operation.

16. The method of claim 15, wherein
the data processing measurement for the particular operation comprise one or more of: time or number of clock cycles to process data or priority level of hardware resource to process the data.

17. The method of claim 15, wherein
the data processing measurement is based on power up of an interface to the hardware resource in the reduced power state and the hardware resource in the reduced power state to operate at a first level of processing.

18. The method of claim 15, wherein the available hardware resources comprise hardware resources enclosed in a casing that encompasses the network interface device.

19. The method of claim 15, wherein the available hardware resources comprise hardware resources connected to the network interface device via an interface.

20. The method of claim 15, wherein the selecting the hardware resource among the available hardware resources based on a time to process the data by the particular operation is to prioritize use of a hardware resource in the network interface device.
